(19) United States
(12) Patent Application Publication
(10) Pub. No.: US 2026/0050913 A1
(43) Pub. Date: Feb. 19, 2026

(54) METHOD AND SYSTEM FOR SECURELY MANAGING PRIVATE WALLET

(71) Applicant: Elisa Oyj, Helsinki (FI)

(72) Inventor: Hien TRUONG, Helsinki (FI)

(73) Assignee: Elisa Oyj, Helsinki (FI)

(21) Appl. No.: 19/103,855

(22) PCT Filed: Aug. 17, 2023
(86) PCT No.: PCT/FI2023/050474

§ 371 Date: Feb. 14, 2025

(30) Foreign Application Priority Data
Aug. 31, 2022 (FI) 20225761

(51) Int. Cl. G06Q 20/36; G06Q 20/38; G06Q 20/40

(52) U.S. Cl. CPC G06Q 20/3674; G06Q 20/3829; G06Q 20/40145

(57) ABSTRACT

A method for securely managing a private wallet. The method includes generating and storing a public key and a private key associated with a digital asset in the private wallet in a dedicated memory hardware of a primary user device, wherein the public key and the private key provide access to the digital asset; extracting a biometric input associated with a user and generating a biometric signature from the extracted biometric input; and linking the generated biometric signature to the private key for adding a security layer to access the private key.

### TECHNICAL FIELD

The present disclosure relates to a method for securely managing a private wallet. The present disclosure also relates to a system for managing a private wallet.

### BACKGROUND

Generally, a pair of public key and private key is associated with a digital asset, where access to the public and the private key is essential in order to access and perform any function with the digital asset. Conventionally, these public and private keys are thus safely stored in a private wallet present on a device of the owner of the associated digital assets.

Typically, the private wallet is present in the device in secure storage memory where the private wallet is safe from external spams and theft attempts. However, in many cases the owner may lose their stored data in the private wallet due to malfunctioning by various unpredictable reasons, for example if the device gets stolen or broken. Thus, there are mechanisms that ensures that the owner does not lose the access to the keys associated to the digital assets. However, known mechanisms fail to provide a user-friendly way which does not involve remembering things and also compromise the privacy of the user.

Therefore, in light of the foregoing discussion, there exists a need to overcome the aforementioned drawbacks associated with the secure management of a private wallet.

### SUMMARY

The present disclosure seeks to provide a method for securely managing a private wallet. The present disclosure also seeks to provide a system for securely managing a private wallet. An aim of the present disclosure is to provide a solution that overcomes at least partially the problems encountered in prior art.

In a first aspect, an embodiment of the present disclosure provides a method for securely managing a private wallet, the method comprising:
generating and storing a public key and a private key associated with a digital asset in a private wallet in a dedicated memory hardware of a primary user device, wherein the public key and the private key provide access to the digital asset;
extracting, via a biometric interface, a biometric input associated with a user and generating a biometric signature from the extracted biometric input; and
linking the generated biometric signature to the private key for adding a security layer to access the private key, wherein linking the generated biometric signature to the private key provides security while accessing the private key.

In a second aspect, an embodiment of the present disclosure provides a system for securely managing a private wallet, the system comprising a primary user device comprising a processor configured to:
generate and store a public key and a private key associated with a digital asset in the private wallet in a dedicated memory hardware of the primary user device, wherein the public key and the private key to provide an access to the digital asset;
extract, via a biometric interface, a biometric input associated with a user and generate a biometric signature from the extracted biometric input; and
link the generated biometric signature to the private key for adding a security layer to access the private key, wherein linking the generated biometric signature to the private key provides security while accessing the private key.

Embodiments of the present disclosure substantially eliminate or at least partially address the aforementioned problems in the prior art, and enable the secure management of the private wallet i.e., storing, backup and recovery of the keys associated with the digital asset in the private wallet, wherein the storing, backup and recovery of the keys are linked to a biometric input of a user. Moreover, the present disclosure aims to provide a more accurate way of using biometric inputs, thus reducing the differences between two different readings of the same biometric input.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart depicting steps of a method for securely managing a private wallet, in accordance with an embodiment of the present disclosure;

FIG. 2 is a block diagram of a system for securely managing a private wallet, in accordance with an embodiment of the present disclosure;

FIG. 3 is a block diagram of a system for requesting access to the private key stored in the private wallet, in accordance with an embodiment of the present disclosure;

FIG. 4 is a block diagram of a system for creating a backup of the public key, the private key and the generated biometric signature linked to the private key on a remote backup server, in accordance with an embodiment of the present disclosure; and

FIG. 5 is a block diagram of a system for recovering stored data on the remote backup server to a secondary user device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method for securely managing a private wallet, the method comprising:
generating and storing a public key and a private key associated with a digital asset in the private wallet in a dedicated memory hardware of a primary user device, wherein the public key and the private key provide access to the digital asset;
extracting, via a biometric interface, a biometric input associated with a user and generating a biometric signature from the extracted biometric input; and
linking the generated biometric signature to the private key for adding a security layer to access the private key, wherein linking the generated biometric signature to the private key provides security while accessing the private key.

In a second aspect, an embodiment of the present disclosure provides a system for securely managing a private wallet, the system comprising a primary user device comprising a processor configured to:
generate and store a public key and a private key associated with a digital asset in the private wallet in a dedicated memory hardware of the primary user device, wherein the public key and the private key to provide an access to the digital asset;
extract, via a biometric interface, a biometric input associated with a user and generate a biometric signature from the extracted biometric input; and
link the generated biometric signature to the private key for adding a security layer to access the private key, wherein linking the generated biometric signature to the private key provides security while accessing the private key.

The present disclosure provides the aforementioned method and the aforementioned system for securely managing a private wallet. Embodiments of the present disclosure aim to provide an efficient user-friendly way for securely managing a private wallet i.e., storing, backup and recovery of the keys associated with the digital asset in the private wallet. Herein the storing, backup and recovery of the keys is linked to a biometric input of a user, thus providing the user with secure management of the keys associated with their digital assets via the biometric input of the user itself. Moreover, the present disclosure aims to ensure that the user can recover the lost data of the keys in a way that does not involve remembering complex passwords or phrases while ensuring that the privacy of the user is not compromised. Furthermore, the present disclosure aims to provide a more accurate way of using biometric inputs, thus reducing the differences between two different readings of the biometric input.

The method of the present disclosure is for securely managing a private wallet. Herein, the term “private wallet” refers to a specific memory unit in a digital device that is capable of storing digital assets. Herein, the term “digital asset” refers to any digitally stored material having a certain value which is owned by a company or an individual. Herein, securely managing the private wallet refers to managing the various functions that are performed on the private wallet in association with the digital asset, where some of the functions may be storing, accessing, using, creating a backup, or recovery of the digital asset.

Optionally, the digital asset comprises one or more of: cryptocurrencies, money or digital identities. In this regard, the digital asset may be in the form of a text, graphics, audio, video, animations. Some examples of the digital assets may include cryptocurrencies, money stored in net banking digital wallets, movies, songs or games created by a person that are digitally stored on a mobile phone or a computer.

The method comprises generating and storing a public key and a private key associated with the digital asset in the private wallet in a dedicated memory hardware of a primary user device, wherein the public key and the private key provide access to the digital asset. Herein, the term “public key” refers to a key that is used for encrypting a sensitive data associated with the digital asset, where the public key is publicly accessible to anyone. Herein, the term “private key” refers to a key that is used for decrypting the sensitive data associated with the digital asset, where the access of the private key is kept only with an owner of the digital asset. Thus, in order to access the digital asset for performing any function related to the digital asset, having access to the private key is mandatory.

Herein, the term “primary user device” refers to a device that is associated with the owner of the digital asset. The primary user device may be a mobile phone, a computer or a smartwatch that is associated with the owner of the digital asset. Subsequently, for enabling the owner to manage the digital asset via the primary user device, the public key and the private key associated with the digital asset are generated and stored in the dedicated memory hardware of the primary user device. Herein, the term “dedicated hardware memory” refers to a specific hardware in the primary user device in which the private wallet is present, where the dedicated memory hardware is capable of storing such sensitive data associated with the digital asset while also ensuring to prevent the stored data of the digital asset from malware attacks and theft attempts. Optionally, the dedicated memory hardware may be a specific part of a conventional memory hardware present in the primary user device. Alternatively, the dedicated memory hardware may be a memory component that is separate from the convention memory hardware of the first user device.

Moreover, the method comprises extracting a biometric input associated with a user and generating a biometric signature from the extracted biometric input. Herein, the term “biometric input” refers to data that is related to some specific biometrics of the user i.e., the owner of the digital asset. In this regard, the biometric input is extracted to be stored as an identity of the user in order to validate the authenticity of the user in future. Optionally, the biometric input is one of: a fingerprint, retinal scan, facial scan or voice. The biometric input may be extracted via a biometric interface. Example of such biometric interface can be a fingerprint reading sensor or a camera (or Lidar) for facial scan or microphone or a retinal scanner camera.

Herein, in order to further improve the accuracy of using the biometric input for validation of the user, the biometric signature is generated from the extracted biometric input, as another biometric input extracted at a later stage may not completely match with the previously extracted biometric input due to presence of noise and errors, even though both the biometric inputs are of the same user. Herein, even though if there is any difference in the two biometric inputs, there is not any difference in the respective biometric signatures of the two biometric inputs which can be matched for authenticating the user. Thus, the method provides a more accurate way of matching two different biometric signatures. Optionally, the biometric signature is generated from the biometric input of the user via a fuzzy biometric extractor. Herein, the “fuzzy biometric extractor” refers to a method for generating data from biometrics to be used for security purposes. Subsequently, the method may implement the fuzzy biometric extractor to generate the biometric signature from the biometric input. In one example a first biometric input is used to generate a first biometric signature and a second biometric input is used to generate a second biometric signature. If the first and second biometric signatures are within predefined tolerances, then the signatures are deemed to be same and the first (original) biometric signature can be used as the link. One way of linking the generated biometric signature to the private key is applying XOR between private key and the biometric signature provided that their bitwise lengths are same. This can be reversed using the biometric signature. If the lengths are not same for example padding or truncating can be used to shorten or lengthen one or another. Alternatively both private key and biometric signature might be hashed to generate same length keys for XOR.

Furthermore, the method comprises linking the generated biometric signature to the private key for adding a security layer to access the private key. In this regard, linking of the generated biometric signature to the private key allows to enhance the security in accessing the private key, as in order to access the private key the user is required to authenticate themselves via the generated biometric signature. Subsequently, the public key and the private key and the generated biometric signature linked to the private key are stored in the private wallet in the dedicated memory hardware of the primary user device. Herein, the public key and the private key and the generated biometric signature collectively from now onwards will be termed as “sensitive data”in the present disclosure.

Optionally, the method further comprises receiving a request for accessing the private key from the user in order to access the digital asset. Herein, for the user to perform any function related to the digital asset, the user needs to access the digital asset via accessing the private key. Subsequently, the request for accessing the private key is received by the user.

Optionally, the method further comprises extracting a real time biometric input associated with the user and generating a real time biometric signature from the extracted real time biometric input. Herein, as the access to the private key is linked to the generated biometric signature, thus for accessing the private key the user is to be biometrically authenticated. Subsequently, the real time biometric input associated with the user is extracted and the real time biometric signature is generated from the extracted real time biometric input. Herein, the term “real time biometric input” refers to the biometric input of the user that is extracted in a present moment of time after receiving the request for accessing the private key. Herein, the term “real time biometric signature” refers to the biometric signature that is generated from the real time biometric input.

Optionally, the method further comprises verifying the generated biometric signature with the real time biometric signature and providing access to the private key upon successful verification. In this regard, the biometric identity of the user is authenticated by verified by matching the generated biometric signature with the real time biometric signature. Subsequently, upon successful verification the user is provided the access to the private key that enables the user to perform any desired function with the associated digital asset.

Optionally, the method further comprises:
establishing a secure connection of a remote backup server with the dedicated memory hardware of the primary user device; and
receiving and storing the public key and the private key and the generated biometric signature linked to the private key in a dedicated memory hardware of a remote backup server on successful attestation of the remote backup server. Optionally the secure connection is done using an SSL/TLS protocol to enhance security.

In this regard, since the dedicated memory hardware of the primary user device is storing the sensitive data that is to be prevented from external spam and theft attempts. Thus, the dedicated memory hardware of the primary user device is not allowed to communicate and connect with any random external third-party servers or websites that are not following any certified authentication protocol. Subsequently, the secure connection of a remote backup server with the dedicated memory hardware of the primary user device is established. Optionally, the secure connection may be established by following an SSL/TLS certification protocol. Herein, the term “remote backup server” refers to a server present in a remote location that is used to store a backup of data stored in the dedicated memory hardware of the primary user device, thus the user can restore and access their data once again if it is lost from the primary user device. Thus, upon successful attestation of the remote backup server, the dedicated memory hardware of the secondary user device receives and stores the public key and the private associated with the digital asset, and the generated biometric signature linked to the private key, thus creating a secure backup of the sensitive data for the user.

Optionally, the remote backup server is a backup device or a virtual remote cloud storage server. In this regard, the backup device may be a mobile phone or computer device that is used as the remote backup server for creating the backup of data stored in the dedicated memory hardware of the primary user device. Alternatively, there are third party based virtual remote cloud storage servers that are having verified certification which may be used as the remote backup server. Herein the term “remote cloud storage server” refers to a powerful physical or virtual infrastructure that has been virtualized, to perform application- and information-processing storage and enable accessing of the stored information by users remotely over a network. The remote cloud storage server includes suitable logic, circuitry, interfaces, and/or code that is configured to store, process and/or receive information. It will be appreciated that the remote cloud storage server may be both a single server and/or a plurality of servers operating in a parallel or distributed architecture to operatively couple with the disclosed cloud-based system or similar systems. Examples of the remote cloud storge server include, but is not limited to, a storage server, a web server, an application server, or a combination thereof.

Optionally, the method further comprises:
sharing a hardware signature of a secondary user device and a real-time biometric signature extracted from a real-time biometric input of the user to the remote backup server;
verifying the hardware signature of the secondary user device and the real-time biometric signature with the generated biometric signature; and
receiving and storing the public key and the private key and the generated biometric signature linked to the private key in a dedicated memory hardware of the secondary user device on successful attestation of the secondary user device. Furthermore, the hardware signature (or hardware fingerprint) of the secondary user device contains information of the dedicated memory hardware of the secondary user device. This signature can be done for example by extracting serial number of a device and mac address of the device. Then for example combining those for example using hash function like SHA-256. This gives a fixed-length string which can be used as a hardware signature.

In this regard, in case if the user somehow loses the sensitive data stored on the primary user device and wants to access the digital asset, then the user is required to recover the lost sensitive data on the secondary user device from the backup created in the remote backup server. Herein, the “secondary user device” refers to another device that is associated with the user. Subsequently, the hardware signature of the secondary user device is shared to the remote backup server. Moreover, in order to validate that the authenticity of the user, the real-time biometric signature of the user from the real-time biometric input of the user is shared to the remote backup server. Herein, the term “real-time biometric input” refers to the biometric input of the user that is extracted in a present moment of time when the user wants to recover the lost sensitive data in the secondary user device. Subsequently, the hardware signature of the secondary user device is verified to authenticate that the secondary user device belongs to the user. Moreover, the real-time biometric signature is verified with the generated biometric signature to validate the identity of the user. Furthermore, upon the successful attestation of the secondary user device, the secondary user device receives and stores the public key and the private key and the generated biometric signature linked to the private key in the dedicated memory hardware of the secondary user device. Thus, the user now can again access the digital asset via the public key, the private key and the generated biometric signature linked to the private key that is now stored in the secondary user device.

Optionally, the hardware signature of the secondary user device contains information of the dedicated memory hardware of the secondary user device. In this regard, the hardware signature enables the remote backup server to verify the authenticity of the dedicated hardware memory of the secondary user device and the secondary user device receives the sensitive data associated with the access of the digital asset only upon the successful attestation of the hardware signature of the secondary user device.

Moreover, the present disclosure also relates to the device as described above. Various embodiments and variants disclosed above apply mutatis mutandis to the system.

Throughout the present disclosure, the term “processor” refers to a computational element that is operable to respond to and process instructions given by the user and to control operations of the system. Examples of the processor include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor may refer to one or more individual processors, processing devices and various elements associated with a processing device that may be shared by other processing devices. Additionally, one or more individual processors, processing devices and elements are arranged in various architectures for responding to and processing the instructions that drive the apparatus. It will be appreciated that each apparatus is configured to have the processor therein.

Throughout the present disclosure, the term “remote backup server” refers to a powerful physical or virtual infrastructure that has been virtualized, to perform application- and information-processing storage and enable accessing of the stored information by users remotely over a network. The server includes suitable logic, circuitry, interfaces, and/or code that is configured to store, process and/or receive the information. It will be appreciated that the remote backup server may be both a single server and/or a plurality of servers operating in a parallel or distributed architecture to operatively couple with the disclosed cloud-based system or similar systems. Examples of the remote backup server include, but is not limited to, a storage server, a web server, an application server, or a combination thereof.

Optionally, the processor further configured to:
receive a request for accessing the private key from the user in order to access the digital asset;
extract a real time biometric input associated with the user and generate a real time biometric signature from the extracted real time biometric input; and
verify the generated biometric signature with the real time biometric signature and provide access to the private key upon successful verification.

Optionally, the processor further configured to track the dedicated memory hardware of the primary user device to enable the user to monitor if the primary user device is tampered from external influence. Herein, since the dedicate hardware memory of the primary user device is responsible to save the data stored in the private wallet from spam and theft attempts, thus tracking the dedicated memory hardware of the primary user device enables the user to monitor if there is any attempt to tamper with the primary user device.

### Optionally, the System Further Comprises a Remote Backup Server

configured to:
establish a secure connection with the dedicated memory hardware of the primary user device; and
receive and store the public key and the private key and the generated biometric signature linked to the private key in a dedicated memory hardware of the remote backup server on successful attestation of the remote backup server.

Optionally, the remote backup server is a backup device or a virtual remote cloud storage server.

Optionally, the dedicated memory hardware of the primary user device is connected with the remote backup server using an SSL/TLS protocol.

Optionally, the system further comprises a secondary user device comprising a processor configured to:
share a hardware signature of the secondary user device and a real-time biometric signature generated from a real-time biometric input extracted from the user to the remote backup server, wherein the remote backup server is configured to verify the hardware signature of the secondary user device and the real-time biometric signature with the generated biometric signature; and
receive and store the public key and the private key and the generated biometric signature linked to the private key in a dedicated memory hardware of the secondary user device on successful attestation of the secondary user device.

Optionally, the dedicated memory hardware of the secondary user device is connected with the remote backup server using an SSL/TLS protocol.

Optionally, wherein the hardware signature of the secondary user device contains information of the dedicated memory hardware of the secondary user device.

Optionally, the digital asset comprising one or more of: cryptocurrencies, money or digital identities.

Optionally, the biometric signature is generated from the biometric input of the user via a fuzzy biometric extractor.

Optionally, the biometric input is one of: a fingerprint, retinal scan, facial scan or voice.

Overall, the method provides way to securely managing a private wallet. Synergistic effect of steps of generating and storing public key and a private key and extracting via biometric interface, a biometric input associated with the user and generating biometric signature from the extracted biometric input and linking the generated biometric signature to the private key is that it adds security layer when someone is trying to access the private key. This is important to prevent unauthorized access. This linking provides additional security for accessing the private key. Indeed, private key would be encrypted using the biometric signature as an example. This provides additional security layer and prevents effectively access to the private key from persons other than the user. When accessing the private key, the user would use the biometric interface to form a biometric signature from linked (i.e. previously generated data string such as a biometric signature XOR private key for example). This biometric signature is used then to get the private key. The private key is used in normal way to open encrypted data.

### DETAILED DESCRIPTION OF THE DRAWINGS

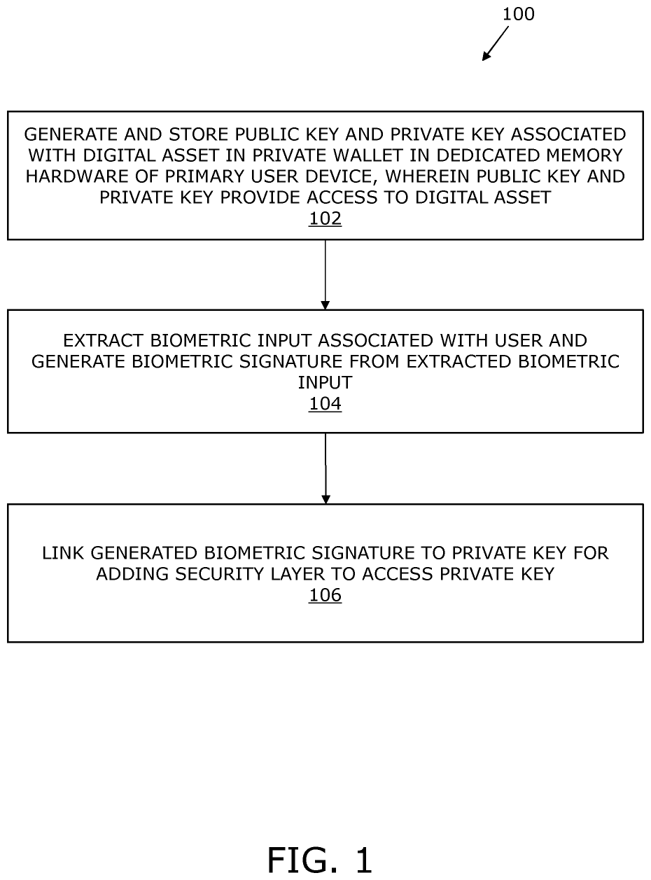

Referring to FIG. 1, illustrated is a flowchart depicting steps of a method 100 for securely managing a private wallet, in accordance with an embodiment of the present disclosure. At step 102, a public key and a private key associated with a digital asset is generated and stored in the private wallet in a dedicated memory hardware of a primary user device, wherein the public key and the private key provide access to the digital asset. At step 104, a biometric input associated with a user is extracted and a biometric signature from the extracted biometric input is generated. At step 106, the generated biometric signature is linked to the private key for adding a security layer to access the private key.

The steps 102, 104, and 106 are only illustrative and other alternatives can also be provided where one or more steps are added, one or more steps are removed, or one or more steps are provided in a different sequence without departing from the scope of the claims herein.

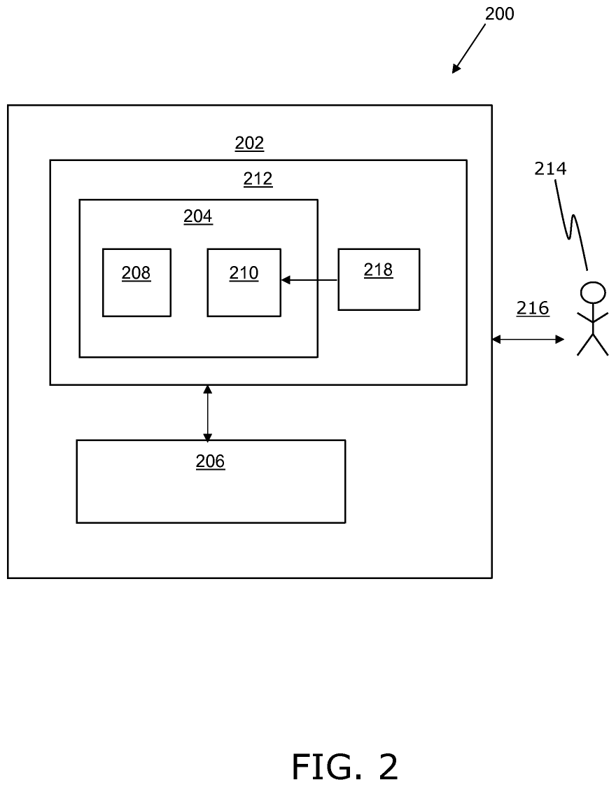

Referring to FIG. 2, Illustrated Is a Block Diagram of a System 200 for securely managing a private wallet 204, in accordance with an embodiment of the present disclosure. Herein, the system 200 comprises a primary user device 202, wherein the primary user device 202 comprises a processor 206. Herein, the processor 206 is configured to generate and store a public key 208 and a private key 210 associated with a digital asset in the private wallet 204 in a dedicated memory hardware 212 of the primary user device 202. Moreover, the processor 206 is configured to extract a biometric input 216 associated with a user 214 and generate a biometric signature 218 from the extracted biometric input 216. Furthermore, the processor 206 is configured to link the generated biometric signature 218 to the private key 210.

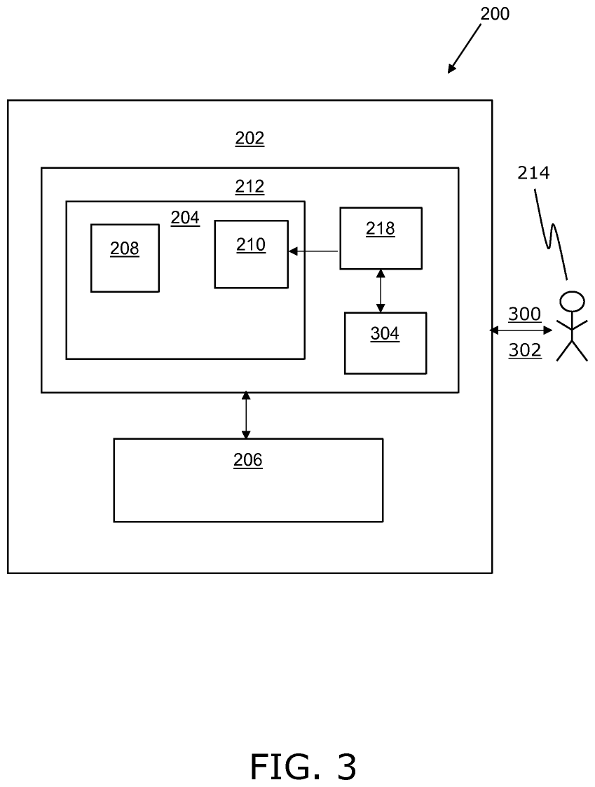

Referring to FIG. 3, illustrated is a block diagram of the system 200 for requesting access to the private key 210 stored in the private wallet 204, in accordance with an embodiment of the present disclosure. Herein, the processor 206 is further configured to receive a request 300 for accessing the private key 210 from the user 214. Additionally, the processor 206 is further configured to extract a real time biometric input 302 associated with the user 214 and generate a real time biometric signature 304 from the extracted real time biometric input 302. Additionally, the processor 206 is further configured to verify the generated biometric signature 218 with the real time biometric signature 304 and provide access to the private key 210 upon successful verification.

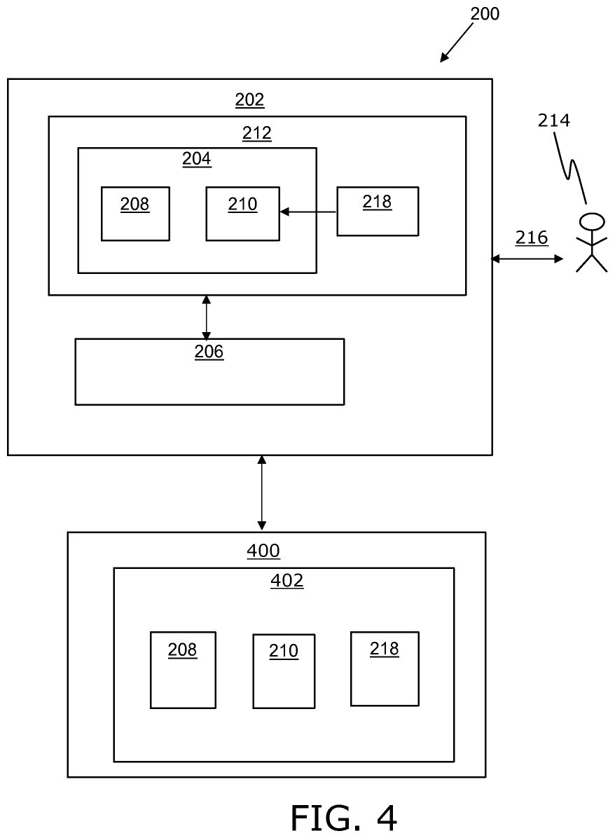

Referring to FIG. 4, illustrated is a block diagram of the system 200 for creating a backup of the public key 208, the private key 210 and the generated biometric signature 218 linked to the private key 210 on a remote backup server 400, in accordance with an embodiment of the present disclosure. Herein, the system 200 further comprises the remote backup server 400, wherein the remote backup server 400 is configured to establish a secure connection with the dedicated memory hardware 212 of the primary user device 202. Moreover, the remote backup server 400 is configured to receive and store the public key 208 and the private key 210 and the generated biometric signature 218 linked to the private key 210 in a dedicated memory hardware 402 of the remote backup server 400 on successful attestation of the remote backup server 400.

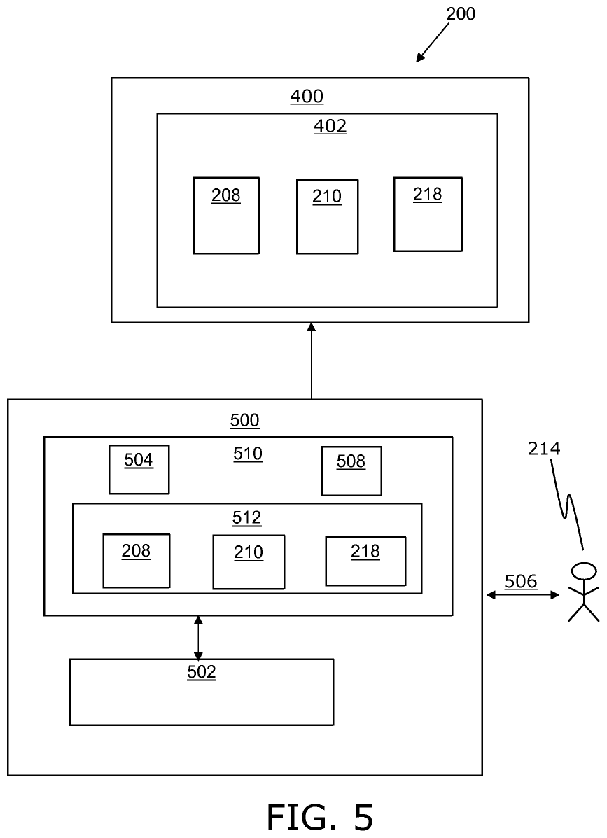

Referring to FIG. 5, illustrated is a block diagram of a system 200 for recovering sensitive data on the remote backup server 400 to a secondary user device 500, in accordance with an embodiment of the present disclosure. Herein, the secondary user device comprises a processor 502 of the secondary user device 500 configured to share a hardware signature 504 of the secondary user device 500 and a real-time biometric signature 508 generated from a real-time biometric input 506 extracted from the user 214 to the remote backup server 400, wherein the remote backup server 400 is configured to verify the hardware signature 504 of the secondary user device 500 and the real-time biometric signature 508 with the generated biometric signature 218. Moreover, the processor 502 of the secondary user device 500 is configured to receive and store the public key 208 and the private key 210 and the generated biometric signature 218 linked to the private key 210 in a secondary private wallet 512 in a dedicated memory hardware 510 of the secondary user device 500 on successful attestation of the secondary user device 500.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-19. (canceled)

20. A method for securely managing a private wallet, the method comprising:
generating and storing a public key and a private key associated with a digital asset in the private wallet in a dedicated memory hardware of a primary user device, wherein the public key and the private key provide access to the digital asset;
extracting, via a biometric interface, a biometric input associated with a user and generating a biometric signature from the extracted biometric input, wherein the biometric signature is generated from the biometric input of the user via a fuzzy biometric extractor;
linking the generated biometric signature to the private key for adding a security layer to access the private key, wherein linking the generated biometric signature to the private key provides security while accessing the private key;
receiving a request for accessing the private key from the user in order to access the digital asset;
extracting a real time biometric input associated with the user and generating a real time biometric signature from the extracted real time biometric input;
verifying the generated biometric signature with the real time biometric signature and providing access to the private key upon successful verification;
establishing a secure connection of a remote backup server with the dedicated memory hardware of the primary user device using an SSL/TLS protocol; and
receiving and storing the public key and the private key and the generated biometric signature linked to the private key in a dedicated memory hardware of the remote backup server on successful attestation of the remote backup server.

21. The method according to claim 20, wherein the remote backup server is a backup device or a virtual remote cloud storage server.

22. The method according to claim 20, further comprising:
sharing a hardware signature of a secondary user device and a real-time biometric signature extracted from a real-time biometric input of the user to the remote backup server;
verifying the hardware signature of the secondary user device and the real-time biometric signature with the generated biometric signature; and
receiving and storing the public key and the private key and the generated biometric signature linked to the private key in a dedicated memory hardware of the secondary user device on successful attestation of the second user device, wherein the hardware signature of the secondary user device contains information of the dedicated memory hardware of the secondary user device.

23. The method according to claim 20, wherein the digital asset comprises one or more of: cryptocurrencies, money or digital identities.

24. The method according to claim 20, wherein the biometric input is one of: a fingerprint, retinal scan, facial scan or voice.

25. A system for managing a private wallet, the system comprising a primary user device comprising a processor configured to:
generate and store a public key and a private key associated with a digital asset in the private wallet in a dedicated memory hardware of the primary user device, wherein the public key and the private key to provide an access to the digital asset;
extract, via a biometric interface, a biometric input associated with a user and generate a biometric signature from the extracted biometric input, wherein the biometric signature is generated from the biometric input of the user via a fuzzy biometric extractor;
link the generated biometric signature to the private key for adding a security layer to access the private key, wherein linking the generated biometric signature to the private key provides security while accessing the private key;
receive a request for accessing the private key from the user in order to access the digital asset;
extract a real time biometric input associated with the user and generate a real time biometric signature from the extracted real time biometric input; and
verify the generated biometric signature with the real time biometric signature and providing access to the private key upon successful verification,
wherein the system further comprises a remote backup server configured to:
establish a secure connection with the dedicated memory hardware of the primary user device using a Secure Sockets Layer SSL/Transport Layer Security TLS protocol; and
receive and store the public key and the private key and the generated biometric signature linked to the private key in a dedicated memory hardware of the remote backup server on successful attestation of the remote backup server.

26. The system according to claim 25, wherein the processor is further configured to track the dedicated memory hardware of the primary user device to enable the user to monitor if the primary user device is tampered from external influence.

27. The system according to claim 25, wherein the remote backup server is a backup device or a virtual remote cloud storage server.

28. The system according to claims 25, further comprising a secondary user device comprising a processor configured to:
share a hardware signature of the secondary user device and a real-time biometric signature generated from a real-time biometric input extracted from the user to the remote backup server, wherein the remote backup server is configured to verify the hardware signature of the secondary user device and the real-time biometric signature with the generated biometric signature; and
receive and store the public key and the private key and the generated biometric signature linked to the private key in a dedicated memory hardware of the secondary user device on successful attestation of the secondary user device, wherein the hardware signature of the secondary user device contains information of the dedicated memory hardware of the secondary user device.

29. The system according to claim 28, wherein the dedicated memory hardware of the secondary user device is connected with the remote backup server using an SSL/TLS protocol.

30. The system according to claim 25, wherein the digital asset comprises one or more of: cryptocurrencies, money or digital identities.

31. The system according to claim 25, wherein the biometric input is one of: a fingerprint, retinal scan, facial scan or voice.
